(19) United States
(12) Patent Application Publication
(10) Pub. No.: US 2015/0258846 A1
(43) Pub. Date: Sep. 17, 2015

(54) Method for Producing a Substrate Having an Image on at Least One Surface

(71) Applicant: Evan R. DANIELS, Dallas, TX (US)

(72) Inventor: Evan R. Daniels, Frisco, TX (US)

(21) Appl. No.: 14/435,061

(22) PCT Filed: Oct. 11, 2013
(86) PCT No.: PCT/US2013/064435

§ 371 Date: Apr. 10, 2015

Related U.S. Application Data
(60) Provisional application No. 61/713,240, filed on Oct. 12, 2012.

(51) Int. Cl. B44F 9/02; B41M 5/00; B44C 1/22

(52) U.S. Cl. CPC B44F 9/02; B44C 1/227; B41M 5/0047; B41M 5/007

(57) ABSTRACT

A method, apparatus and system for producing an image on one or more surfaces of a gypsum or cement composite substrate by etching the one or more surfaces of the gypsum or composite substrate transferring the image to the one or more surfaces of the gypsum or cement composite substrate using an ink jet process or a rolling die, applying a topcoat on the image and etched surface(s) of the gypsum or cement composite substrate, and curing the image and the topcoat.

### FIELD OF INVENTION

The present invention relates generally to the field of gypsum or cement substrates and more specifically to a method and system for producing an image on one or more surfaces of a gypsum or cement composite substrate.

### BACKGROUND ART

The diminished availability and high cost of hard woods for use as furniture or attractive building materials has proliferated the use of less expensive wood and wood composites. Moreover, wood and wood composites do not have the strength and fire resistant properties provided by gypsum and cement substrates. Attempts to produce images on gypsum and cement substrates, such as wood grain patterns, result in “flat” and very artificial looking images that are worse than inexpensive wood composites are surfaced with colored or printed vinyl, phenolic-backed or similar decorative laminates.

### SUMMARY OF THE INVENTION

The present invention provides a method and system for producing an image on one or more surfaces of a gypsum or cement composite substrate by etching the one or more surfaces of the gypsum or cement composite substrate, transferring the image to the one or more surfaces of the gypsum or cement composite substrate using an ink jet process or a rolling die, applying a topcoat on the image and etched surface(s) of the gypsum or cement composite substrate, and curing the image and the topcoat.

The present invention also provides an apparatus produced by the process of etching the one or more surfaces of the gypsum or cement composite substrate, transferring the image to the one or more surfaces using an ink jet process or a rolling die, applying a topcoat on the image and etched surface(s) of the gypsum or cement composite substrate, and curing the image and the topcoat.

In addition, the present invention provides an apparatus that includes a gypsum or cement composite substrate having at least one etched surface, an image disposed on the etched surface(s) of the gypsum or cement composite substrate, and a topcoat disposed on the image and etched surface(s) of the gypsum or cement composite substrate.

Moreover, the present invention provides a system for producing an image on one or more surfaces of a gypsum or cement composite substrate that includes an etching machine that etches one or more surfaces of the gypsum or cement composite substrate, a printing machine that transferring the image to the one or more surfaces of the gypsum or cement composite substrate, a coating machine that applies a topcoat to the image and etched surface(s) of the gypsum or cement composite substrate, and an oven or UV light machine that cures the image and the topcoat.

### BRIEF DESCRIPTION OF THE DRAWINGS

Further benefits and advantages of the present invention will become more apparent from the following description of various embodiments that are given by way of example with reference to the accompanying drawings:

FIG. 1 is a flow chart of a method for producing an image on one or more surfaces of a gypsum or cement composite substrate in accordance with one embodiment of the present invention;

FIG. 2 is a cross-sectional view of an apparatus produced in accordance with the present invention; and

FIG. 3 is a block diagram of a system for producing an image on one or more surfaces of a gypsum or cement composite substrate in accordance with one embodiment of the present invention.

### DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

The following patents and applications are hereby incorporated by reference in their entirety: (a) U.S. Pat. No. 6,964,722 entitled “Method for Producing a Wood Substrate Having an Image on at Least One Surface” issued Nov. 15, 2005; (b) U.S. Patent Application Ser. No. 61/545,771 entitled “Fire Rated Door Core” filed on Oct. 11, 2011; (c) U.S. patent application Ser. No. 13/646,292 entitled “Fire Rated Door Core” filed on Oct. 5, 2012; (d) U.S. patent application Ser. No. 13/538,788 filed Jun. 29, 2012; (e) U.S. patent application Ser. No. 13/603,405 entitled “Gypsum Composites Used in Fire Resistant Building Components” filed Sep. 4, 2012; (f) U.S. patent application Ser. No. 13/610,542 entitled “Gypsum Composites Used in Fire Resistant Building Components” filed Sep. 11, 2012; and (g) U.S. patent application Ser. No. 13/538,828 entitled “Fire Rated Door” filed Jun. 29, 2012. The methods described herein are useable with the systems, devices and methods described in these patents and patent applications.

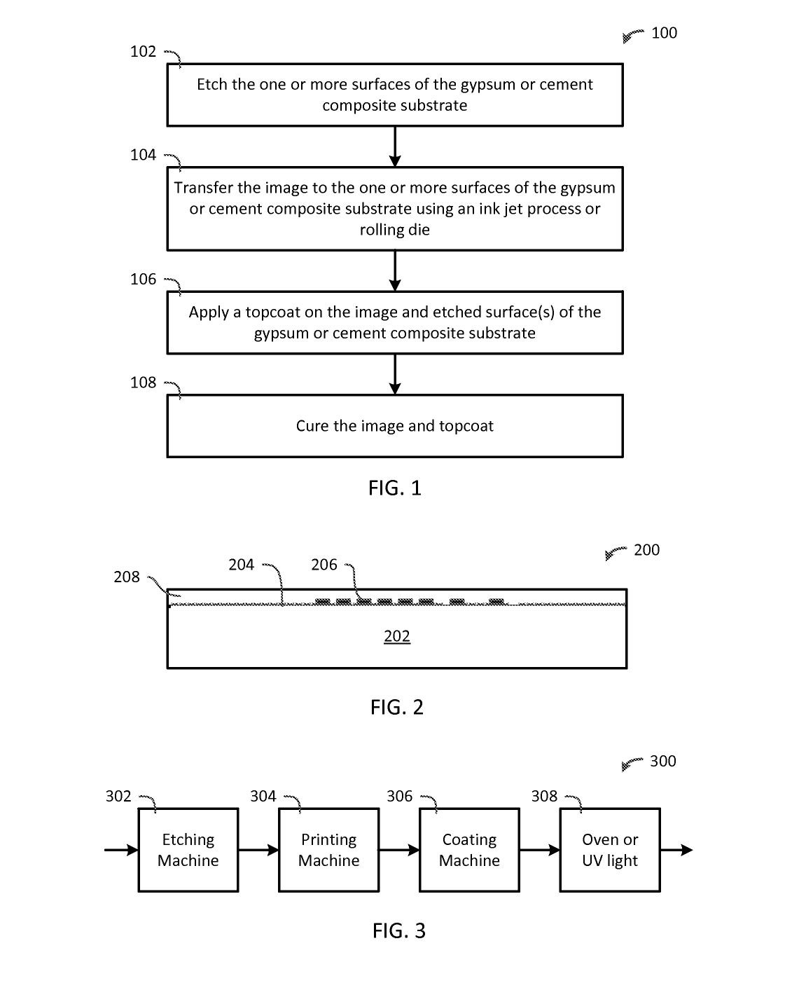

Now referring to FIG. 1, a flow chart of a method 100 for producing an image on one or more surfaces of a gypsum or cement composite substrate in accordance with one embodiment of the present invention is shown. The one or more surfaces of the gypsum or cement composite substrate are etched in block 102. The substrate can be a panel, door, a table top, a molding, a countertop, or a part of the foregoing. The etching can be performed using a metal stripper and does not require the use of a specific pattern. The etching can also be performed using a rolling die (e.g., 24″) to form a wood grain pattern in the substrate. The image is transferred to the one or more surfaces of the gypsum or cement composite substrate using an ink jet process or rolling die in block 104. Other image transfer processes can be used. A topcoat is applied on the image and etched surface(s) of the gypsum or cement substrate in block 106. The image and the topcoat are cured in block 108. Although the image can be any desirable design or effect, a preferred image is a wood grain pattern. The wood grain pattern can be of any wood type. The etching provides a depth to the wood grain image such that the wood grain image appears real. The ink jet processes may use two or more inks that are curable using an ultraviolet light. The topcoat may also be curable using the ultraviolet light. The image and topcoat can be cured using the ultraviolet light, either separately or in one step. The image and topcoat can be applied to two or more surfaces of the substrate, such as a top and two or more sides of the substrate. The one or more surfaces of the substrate can be substantially planar or have a varying cross section, such as the one or more surfaces of the substrate varies in one dimension, or the one or more surfaces of the substrate varies in two dimensions.

Other steps may include: (a) sanding the one or more surfaces of the gypsum or cement composite substrate prior to etching; (b) placing the gypsum or cement composite substrate on an indexing table prior to transferring the image; (c) trimming or cutting the gypsum or cement composite substrate; (d) applying a receptor coat to the one or more surfaces of the gypsum or concrete substrate prior to transferring the image; (e) forming the gypsum or concrete substrate; (f) preparing the one or more surfaces of the substrate, such as shaping, edging, forming, routing, drilling, creating hardware recesses, sanding or cutting of the substrate; (g) pre-finishing the one or more surfaces of the substrate, such as cleaning, polishing, sanding, sealing, staining or fillcoating the substrate; or (h) cleaning the one or more surfaces of the substrate.

As a result and as shown in FIG. 2, the present invention provides an apparatus produced by the process of etching the one or more surfaces of the gypsum or cement composite substrate, transferring the image to the one or more surfaces using an ink jet process or a rolling die, applying a topcoat on the image and etched surface(s) of the gypsum or cement composite substrate, and curing the image and the topcoat.

Referring now to FIG. 2, a cross-sectional view of an apparatus 200 produced in accordance with the present invention is shown. The apparatus 200 includes a gypsum or cement composite substrate 202 having at least one etched surface 204, an image 206 disposed on the etched surface(s) 204 of the gypsum or cement composite substrate 202, and a topcoat 208 disposed on the image 206 and etched surface(s) 204 of the gypsum or cement composite substrate 202.

Referring now to FIG. 3, a block diagram of a system 300 for producing an image on one or more surfaces of a gypsum or cement composite substrate in accordance with one embodiment of the present invention is shown. The system 300 includes an etching machine 302 that etches one or more surfaces of the gypsum or cement composite substrate, a printing machine 304 that transferring the image to the one or more surfaces of the gypsum or cement composite substrate, a coating machine 306 that applies a topcoat to the image and etched surface(s) of the gypsum or cement composite substrate, and an oven or UV light machine 308 that cures the image and the topcoat.

For example, one embodiment of the present invention for a printing and etching line with Trabattoni and Superfici machines on ⅛″ HDF/5′ wide can be performed using the following equipment:

1. De-stacker and feeder;

2. Wide belt sander/calibrating machine 54″ (top);

3. Indexing table for 0/0 axis (top left);

4. Etching machine with a 5′ heated roller that indexes the start/stop location;

5. Automation to convey panels to the printing line;

6. Ink jet printing machines with UV ink and lights (oven);

7. Conveyor to unload ink jet machines forward on main conveyor line;

8. Panels go through a top coat application machine with UV clear coat material and lights (oven); and

9. Panels move forward and are re-stacked by a panel stacker to be sorted, stretched wrapped and sent back out on pallets to inventory.

Another embodiment of the present invention for a moulding line using gypsum based material in 2′ wide sheets can be performed using the following equipment:

1. Gang rip saw 2′ wide (6 auger/60 HP);

2. Moulder (multi profile 8″);

3. Etcher/sander (4 sets-2 top/2 side);

4. Ink jet printing machines with UV ink and lights (oven);

5. Finishing top coater with UV clear coat material and lights (oven);

6. Cross cutter (included); and

7. Stacker/material handling.

The present invention also provides a method for gluing components together by spraying the glue on in a thin layer that is controllable with a high degree of precision. For example, the steps may include providing a first gypsum or concrete composite substrate, spraying a first thin layer of glue on a top surface of the first gypsum or concrete composite substrate, pressing a second gypsum or concrete composite substrate on the first thin layer of glue, spraying a second thin layer of glue on a top surface of second first gypsum or concrete composite substrate, and pressing a third gypsum or concrete composite substrate on the second thin layer of glue. The first and third gypsum or concrete composite substrates can be a first fire resistant material, and the second gypsum or concrete can be a second fire resistant material. Note that the process can be applied to only two substrates.

In addition, the present invention provides a method for gluing components together by providing a first wood or wood composite substrate, spraying a first thin layer of glue on a top surface of the first wood or wood composite substrate, pressing a protective layer on the first thin layer of glue, spraying a second thin layer of glue on a top surface of protective layer, and pressing a second wood or wood composite substrate on the second thin layer of glue. The protective layer can be a fire resistant material, sound dampening material, bullet resistant material or any other desirable material to provide one or more protective properties. Note that the process can be applied to only two substrates.

For example, one embodiment of the present invention for a glue line for door faces to fire core with ITW, Union Tool and Superfici machines on ⅛″ HDF can be performed using the following equipment:

1. De-stacker and feeder;

2. Wide belt sander/calibrating machine 54″ (top);

3. Indexing table for 0/0 axis (top left);

4. Glue spraying machine with ITW fixed heads to spray fire core, and automated drum feeders for the glue;

5. Indexing table for 0/0 axis (top left);

6. Lay up machine to drop one face onto core;

7. Pinch roller;

8. Robot and conveyor to send finished panels forward or send other panels to go again for second pass to other side;

9. Panels that go around for the other side go through a barrel turner and are indexed back to the front for the second process; and

10. Panels that go forward are re-stacked by a panel stacker to be sorted, stretched wrapped and sent back out on pallets to inventory.

Although preferred embodiments of the present invention have been described in detail, it will be understood by those skilled in the art that various modifications can be made therein without departing from the spirit and scope of the invention as set forth in the appended claims.

1. A method for producing an image on one or more surfaces of a gypsum or cement composite substrate, comprising the steps of:
etching the one or more surfaces of the gypsum or cement composite substrate;
transferring the image to the one or more surfaces of the gypsum or cement composite substrate using an ink jet process;
applying a topcoat on the image and etched surface(s) of the gypsum or cement composite substrate; and
curing the image and the topcoat.

2. The method as recited in claim 1, wherein the image is a wood grain, and the etching provides a depth to the wood grain image such that the wood grain image appears real.

3. The method as recited in claim 1, wherein:
the ink jet processes uses two or more inks that are curable using a ultraviolet light;
the topcoat is curable using the ultraviolet light; and
the image and the topcoat are cured using the ultraviolet light.

4. The method as recited in claim 1, further comprising the step of sanding the one or more surfaces of the gypsum or cement composite substrate prior to etching.

5. The method as recited in claim 1, wherein the image is cured prior to applying the topcoat.

6. The method as recited in claim 1, further comprising the step of placing the gypsum or cement composite substrate on an indexing table prior to transferring the image.

7. The method as recited in claim 1, wherein the step of etching the one or more surfaces does not use a pattern.

8. The method as recited in claim 1, further comprising the step of trimming or cutting the gypsum or cement composite substrate.

9. The method as recited in claim 1, wherein the substrate is a panel, door, a table top, a molding or a countertop.

10. The method as recited in claim 1, further comprising the step of applying a receptor coat to the one or more surfaces of the gypsum or concrete substrate prior to transferring the image.

11. The method as recited in claim 1, further comprising the step of forming the gypsum or concrete substrate.

12. The method as recited in claim 1, wherein the etching is performed using a metal stripper.

13. The method as recited in claim 1, further comprising the steps of:
providing a first gypsum or concrete composite substrate;
spraying a first thin layer of glue on a top surface of the first gypsum or concrete composite substrate;
pressing a second gypsum or concrete composite substrate on the first thin layer of glue;
spraying a second thin layer of glue on a top surface of second first gypsum or concrete composite substrate; and
pressing a third gypsum or concrete composite substrate on the second thin layer of glue.

14. The method as recited in claim 13, wherein:
the first and third gypsum or concrete composite substrates comprise a first fire resistant material; and
the second gypsum or concrete composites a second fire resistant material.

15. The method as recited in claim 1, wherein the one or more surfaces of the substrate are substantially planar.

16. The method as recited in claim 1, wherein a cross section of the one or more surfaces of the substrate varies in one dimension.

17. The method as recited in claim 1, wherein a cross section of the one or more surfaces of the substrate varies in two dimensions.

18. The method as recited in claim 1, further comprising the step of preparing the one or more surfaces of the substrate.

19. The method as recited in claim 18, wherein the step of preparing the one or more surfaces of the substrate includes shaping, edging, forming, routing, drilling, creating hardware recesses, sanding or cutting of the substrate.

20. The method as recited in claim 1, further comprising the step of pre-finishing the one or more surfaces of the substrate.

21. The method as recited in claim 20, wherein the step of pre-finishing the one or more surfaces of the substrate includes cleaning, polishing, sanding, sealing, staining or fillcoating the substrate.

22. The method as recited in claim 1, further comprising the step of cleaning the one or more surfaces of the substrate.

23. The method as recited in claim 1, wherein the image and the topcoat are applied to two or more surfaces of the substrate.

24. The method as recited in claim 23, wherein the two or more surfaces include a top and two or more sides of the substrate.

25. A method for producing an image on one or more surfaces of a wood or wood composite substrate, comprising the steps of:
etching a pattern into the one or more surfaces of the wood or wood composite substrate using a rolling die;
transferring the image to the one or more surfaces using an ink jet process;
applying a topcoat on the image and etched surface(s) of the wood or wood composite substrate; and
curing the image and the topcoat.

26. The method as recited in claim 25, wherein the image is a wood grain, and the etching provides a depth to the wood grain image such that the wood grain image appears real.

27. The method as recited in claim 25, wherein:
the ink jet processes uses two or more inks that are curable using a ultraviolet light;
the topcoat is curable using the ultraviolet light; and
the image and the topcoat are cured using the ultraviolet light.

28. The method as recited in claim 25, further comprising the step of sanding the one or more surfaces of the wood or wood composite substrate prior to etching.

29. The method as recited in claim 25, wherein the image is cured prior to applying the topcoat.

30. The method as recited in claim 25, further comprising the step of placing the wood or wood composite substrate on an indexing table prior to transferring the image.

31. The method as recited in claim 25, further comprising the step of trimming or cutting the wood or wood composite substrate.

32. The method as recited in claim 25, wherein the substrate is a panel, door, a table top, a molding or a countertop.

33. The method as recited in claim 25, further comprising the step of applying a receptor coat to the one or more surfaces of the wood or wood composite prior to transferring the image.

34. The method as recited in claim 25, further comprising the steps of:
providing a first wood or wood composite substrate;
spraying a first thin layer of glue on a top surface of the first wood or wood composite substrate;
pressing a protective layer on the first thin layer of glue;
spraying a second thin layer of glue on a top surface of protective layer; and
pressing a second wood or wood composite substrate on the second thin layer of glue.

35. The method as recited in claim 34, wherein the protective layer comprises a fire resistant material.

36. The method as recited in claim 25, wherein the one or more surfaces of the substrate are substantially planar.

37. The method as recited in claim 25, wherein a cross section of the one or more surfaces of the substrate varies in one dimension.

38. The method as recited in claim 25, wherein a cross section of the one or more surfaces of the substrate varies in two dimensions.

39. The method as recited in claim 25, further comprising the step of preparing the one or more surfaces of the substrate.

40. The method as recited in claim 39, wherein the step of preparing the one or more surfaces of the substrate includes shaping, edging, forming, routing, drilling, creating hardware recesses, sanding or cutting of the substrate.

41. The method as recited in claim 25, further comprising the step of pre-finishing the one or more surfaces of the substrate.

42. The method as recited in claim 41, wherein the step of pre-finishing the one or more surfaces of the substrate includes cleaning, polishing, sanding, sealing, staining or fillcoating the substrate.

43. The method as recited in claim 25, further comprising the step of cleaning the one or more surfaces of the substrate.

44. The method as recited in claim 25, wherein the image and the topcoat are applied to two or more surfaces of the substrate.

45. The method as recited in claim 44, wherein the two or more surfaces include a top and two or more sides of the substrate.

46. A gypsum or cement composite substrate produced by the process of:
etching the one or more surfaces of the gypsum or cement composite substrate;
transferring the image to the one or more surfaces using an ink jet process or a rolling die;
applying a topcoat on the image and etched surface(s) of the gypsum or cement composite substrate; and
curing the image and the topcoat.

47. A gypsum or cement composite substrate comprising:
a gypsum or cement composite substrate having at least one etched surface;
an image disposed on the etched surface(s) of the gypsum or cement composite substrate; and
a topcoat disposed on the image and etched surface(s) of the gypsum or cement composite substrate.

48. A system for producing an image on one or more surfaces of a gypsum or cement composite substrate comprising:
an etching machine that etches one or more surfaces of the gypsum or cement composite substrate;
a printing machine that transferring the image to the one or more surfaces of the gypsum or cement composite substrate;
a coating machine that applies a topcoat to the image and etched surface(s) of the gypsum or cement composite substrate; and
an oven or UV light machine that cures the image and the topcoat.

49. The system as recited in claim 48, further comprising a conveyor, endless belt, cart or robot that moves the gypsum or cement composite substrate from the etching machine to the printing machine, the coating machine and the oven or UV light machine.
